(19) United States
(12) Patent Application Publication
(10) Pub. No.: US 2011/0272348 A1
(43) Pub. Date: Nov. 10, 2011

(54) IRON-MEDIATED REMEDIATION WITHIN NONAQUOUS PHASE LIQUID

(75) Inventors: Andrew Ramsburg, Boston, MA (US); Nicole Berge, Medford, MA (US)

(73) Assignee: TUFTS UNIVERSITY, Medford, MA (US)

(21) Appl. No.: 13/139,959

(22) PCT Filed: Dec. 16, 2009
(86) PCT No.: PCT/US09/68184

§ 371 Date: Jul. 20, 2011

Related U.S. Application Data
(60) Provisional application No. 61/122,923, filed on Dec. 16, 2008.

(51) Int. Cl. C02F 3/00

(52) U.S. Cl. 210/601

(57) ABSTRACT

The present invention relates to remediation of hazardous waste sites. In particular, the present invention relates to compositions and methods for remediation of environmental contaminants in non-aqueous phase liquids (NAPLs).

### CROSS REFERENCE TO RELATED APPLICATIONS

This application claims priority to U.S. Provisional Patent Application Ser. No. 61/122,923, filed: Dec. 16, 2008, which is herein incorporated by reference in its entirety.

### STATEMENT REGARDING FEDERALLY SPONSORED RESEARCH OR DEVELOPMENT

This invention was made with government support under contract W912HQ-06-C-0032 awarded by the U S Army Corps of Engineers, Humphreys Center Support Activity The government has certain rights in the invention.

### FIELD OF THE INVENTION

The present invention relates to remediation of hazardous waste sites. In particular, the present invention relates to compositions and methods for remediation of environmental contaminants in non-aqueous phase liquids (NAPLs).

### BACKGROUND OF THE INVENTION

Nonaqueous phase liquids (NAPLs) are present at numerous hazardous waste sites and are suspected to exist at many more. NAPL is a term used to describe the physical and chemical differences between a hydrocarbon liquid and water which result in a physical interface between two liquid phases. The interface is a physical dividing surface between the bulk phases of the two liquids. Components (solutes) in either phase may partition (dissolve) between phases. With respect to contaminated sites, the NAPL typically represents an organic phase which slowly dissolves into the groundwater moving through the source area (the region of a site containing NAPL).

Nonaqueous phase liquids have typically been divided into two general categories, dense and light. These terms describe the specific gravity, or the density of the nonaqueous phase liquid relative to that of water. Correspondingly, dense nonaqueous phase liquids (DNAPLs) have specific gravities greater than that of water, and the light nonaqueous phase liquids (LNAPLs) have specific gravities less than that of water. Due to the numerous variables influencing NAPL transport and fate in the subsurface, and consequently, the ensuing complexity, NAPLs are largely undetected and yet are a significant limiting factor in site remediation.

The general chemical categories are halogenated/non-halogenated semi-volatiles and halogenated volatiles. These compounds are typically found in the following wastes and waste-producing processes: industrial dry cleaning and degreasing operations, wood preserving wastes (creosote, pentachlorophenol), fuel refining, transport and storage, production of manufactured gas (e.g., coal tars), and pesticide manufacturing. The most frequently cited group of these contaminants to date are the chlorinated solvents.

Because of the way DNAPLs move and distribute themselves in the subsurface they are particularly difficult to detect and remediate (FIG. 1). Depending upon the source zone architecture (spatial distribution of DNAPL) and location (e.g., above or below the water table, in deep or shallow unconsolidated soils or fractured bedrock), different treatment approaches may be appropriate. In the past, unless the source zone was amenable to excavation and treatment or to removal by soil vapor extraction, it was either recovered to the extent practicable or given a technical impracticability waiver and left in place with some form of containment system to prevent offsite migration of contaminated ground water.

Additional methods are needed in remediation of NAPL source zones. Particularly needed are low cost, effective remediation methods.

### SUMMARY OF THE INVENTION

The present invention relates to remediation of hazardous waste sites. In particular, the present invention relates to compositions and methods for remediation of environmental contaminants in non-aqueous phase liquids (NAPLs).

In some embodiments, the present invention provides compositions and methods for remediation of environmental contaminants (e.g., halogenated compounds) directly within NAPLs. The compositions and methods of the present invention are amendable to the remediation of multiple contaminants within NAPLs that are amenable to remediation via chemical or biological reaction (e.g., iron reduction). The present invention is exemplified using reactive iron based remediation of halogenated contaminants. However, the present invention is not limited to these methods and is generally applicable to remediation reactions that occur within NAPLs. These methods provide advantages in ease of use, effectiveness and safety over methods that require diffusion of contaminants out of NAPLs for remediation.

For example, in some embodiments, the present invention provides a method of neutralizing environmental contaminants within non-aqueous phase liquids, comprising: Contacting a non-aqueous phase liquid (NAPL) comprising environmental contaminants with a reactive zero valent iron (ZVI) under conditions such that the ZVI neutralizes the environmental contaminant within the NAPL. The present invention is not limited to a particular source of ZVI iron. Any suitable ZVI particle may be utilized. In some embodiments, the ZVI is a reactive nanoscale iron particle (RNIP), a submicron scale iron particle or an MTI iron particle. In some embodiments, the environmental contaminant is a halogenated methane, ethane, ethene or benzene (e.g., halogenated with carbon tetrachloride, chloroform, trichloroethene, and trichloroethane). In some embodiments, the NAPL comprises more than one distinct environmental contaminant. In some embodiments, the non-aqueous phase liquid is a dense non-aqueous phase liquid (DNAPL). In some embodiments, the ZVI is encapsulated in an emulsion (e.g., an oil in water emulsion). In some embodiments, the emulsion comprises soybean oil, butanol, surfactants, and/or gum arabic.

### DESCRIPTION OF THE FIGURES

FIG. 1 shows a diagram of NAPL environmental contamination.

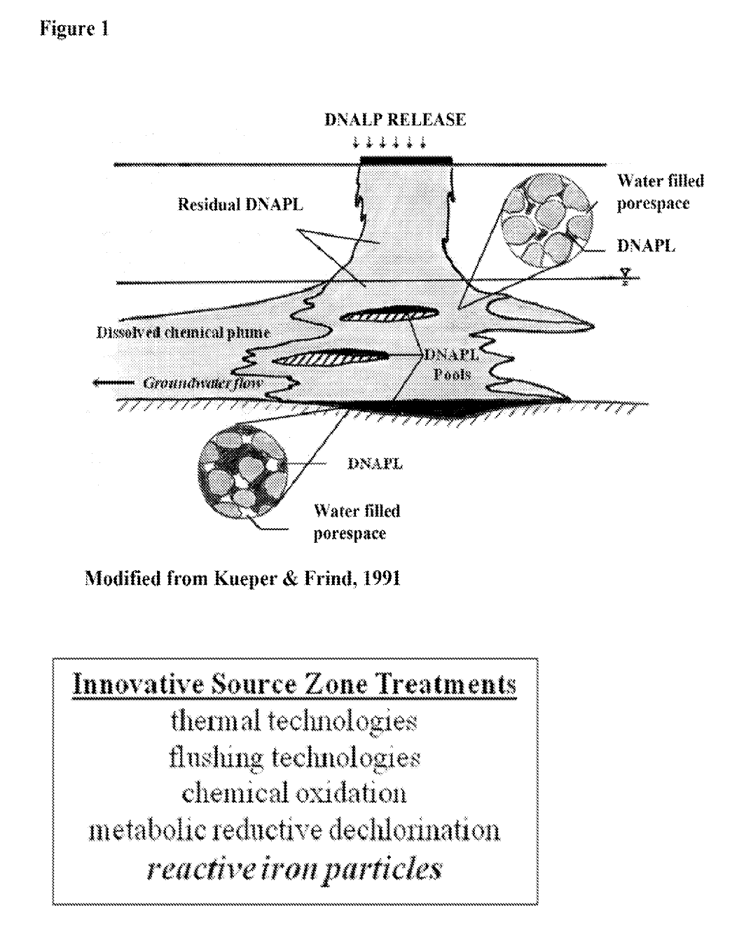

FIG. 2 shows iron containing oil-in-water emulsion.

FIG. 3 shows transport of iron containing oil-in-water emulsion.

FIG. 4 shows gas (e.g., product) production for several NAPLs of increasing water content.

FIG. 5 shows water consumption within NAPL.

FIG. 6 shows electron utilization within the NAPL.

FIG. 7 shows emulsion based targeted delivery of reactive iron particles.

FIG. 8 shows expected enhancements in oil-phase water content when using Span 80 in the emulsion formulation.

FIG. 9 shows alternative iron products.

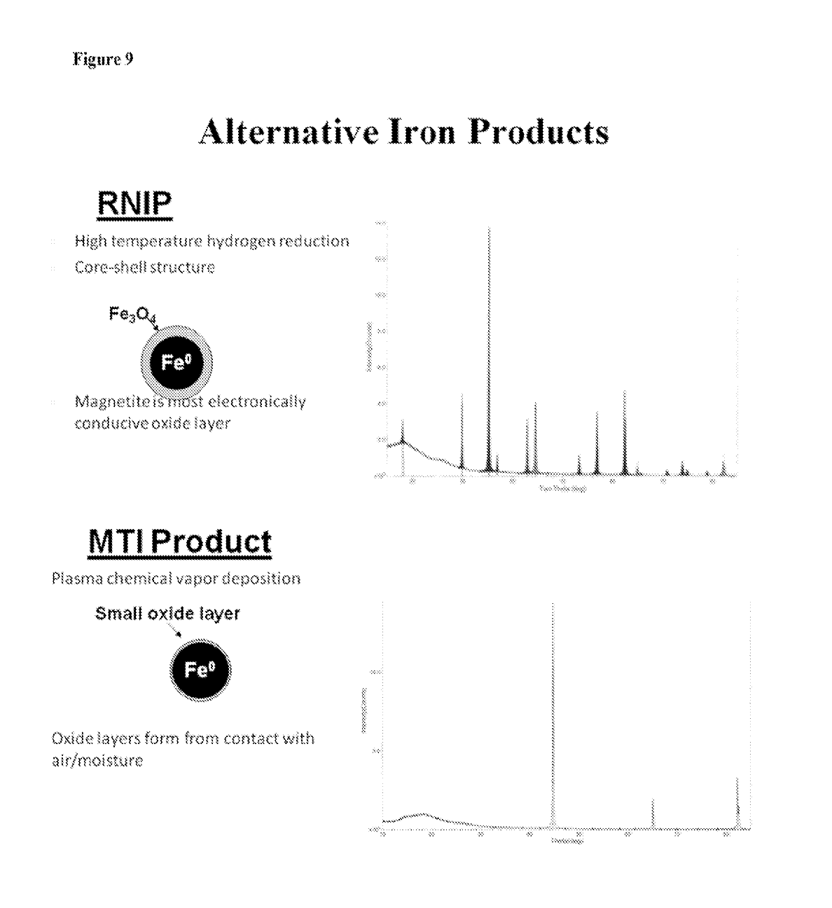

FIG. 10 shows TCE reduction with a variety of alternative iron products.

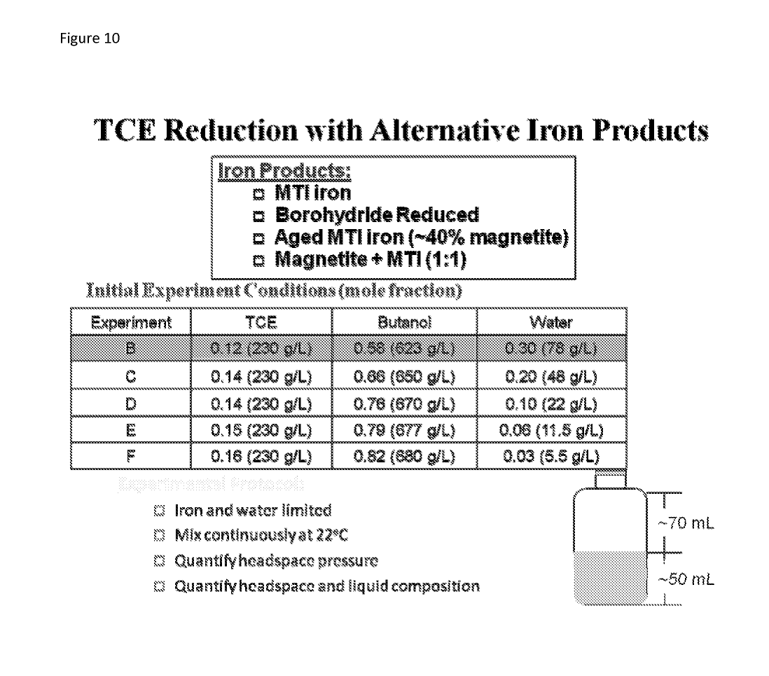

FIG. 11 shows water composition of TCE reduction with a variety of alternative iron products.

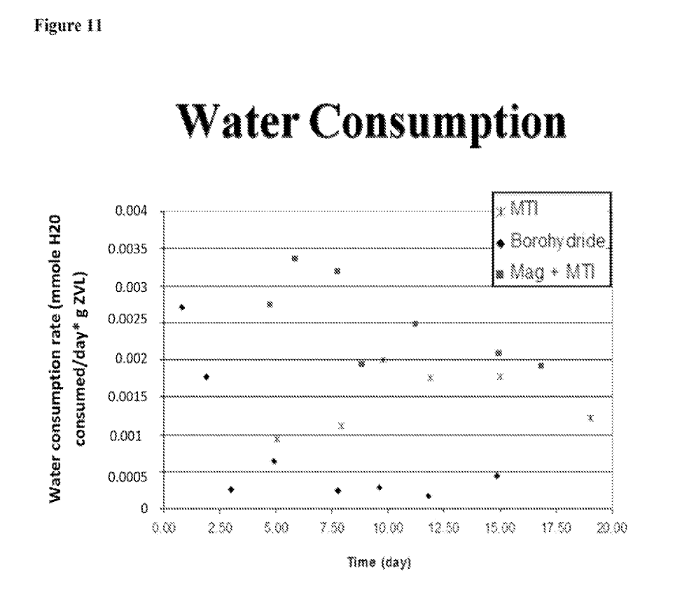

FIG. 12 shows product composition of TCE reduction with a variety of alternative iron products.

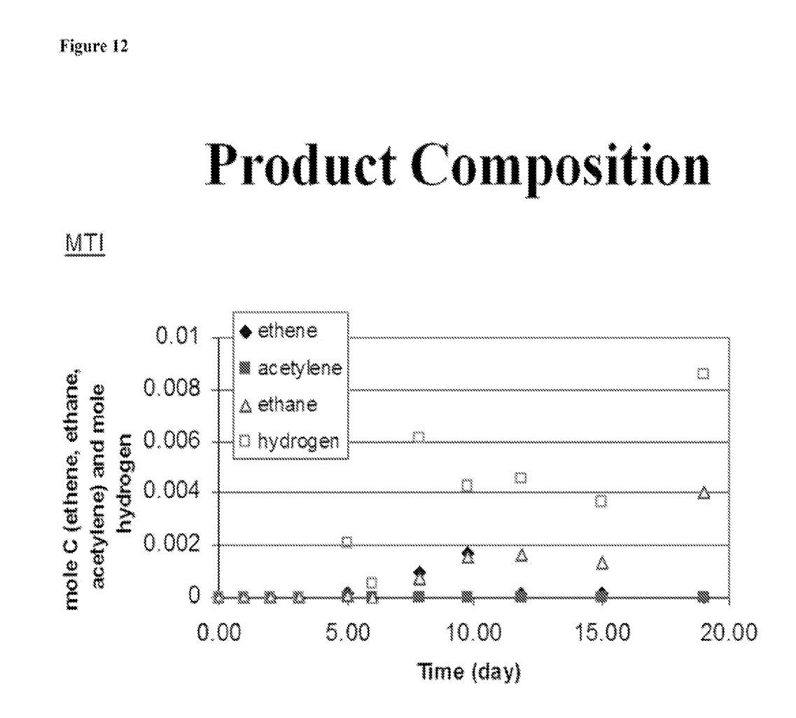

FIG. 13 shows product composition of TCE reduction with a variety of alternative iron products.

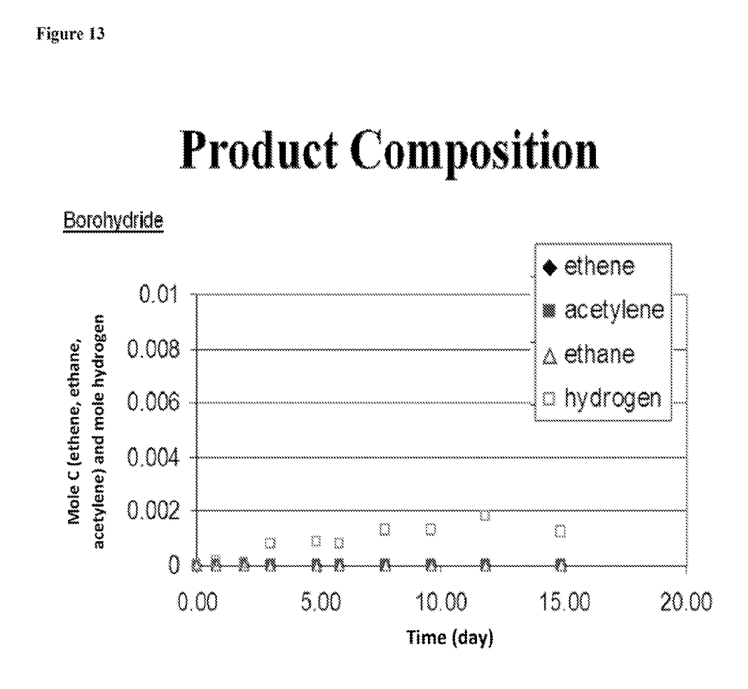

FIG. 14 shows product composition of TCE reduction with a variety of alternative iron products.

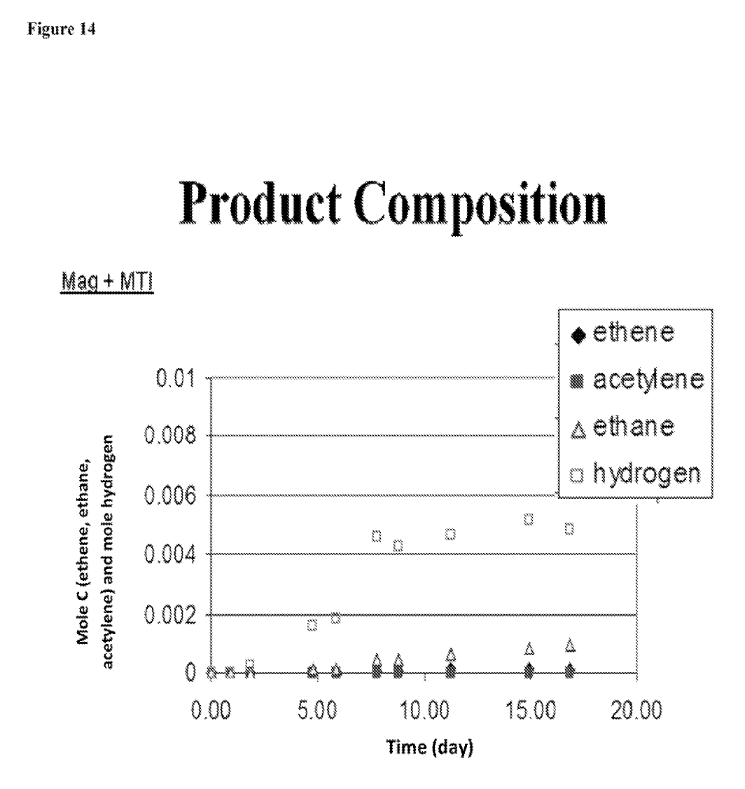

FIG. 15 shows product production of TCE reduction with a variety of alternative iron products.

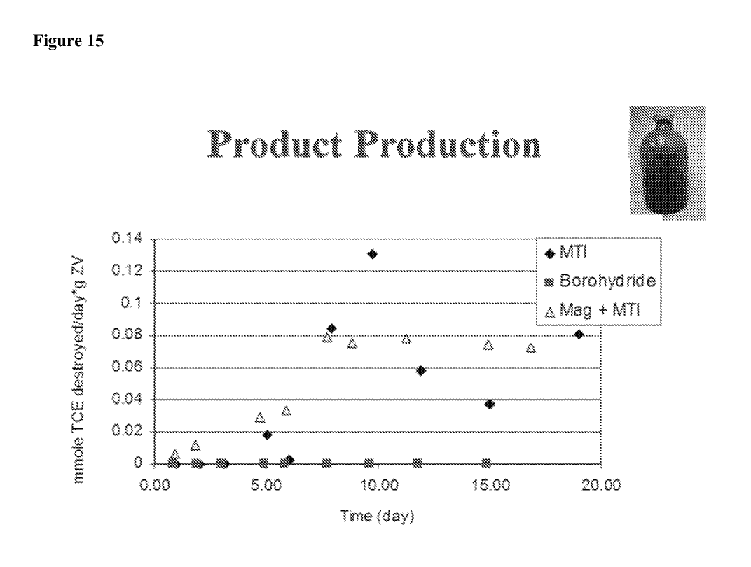

FIG. 16 shows electron efficiency of TCE reduction with a variety of alternative iron products.

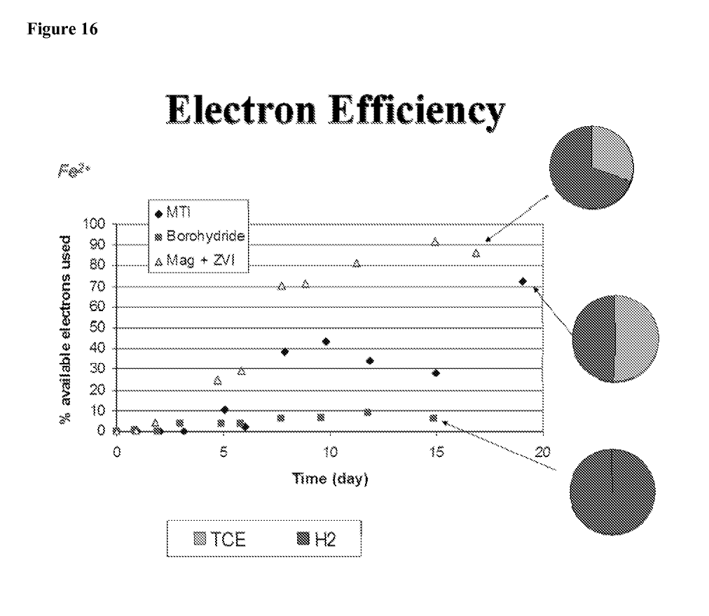

FIG. 17 shows electron efficiency of TCE reduction with a variety of alternative iron products.

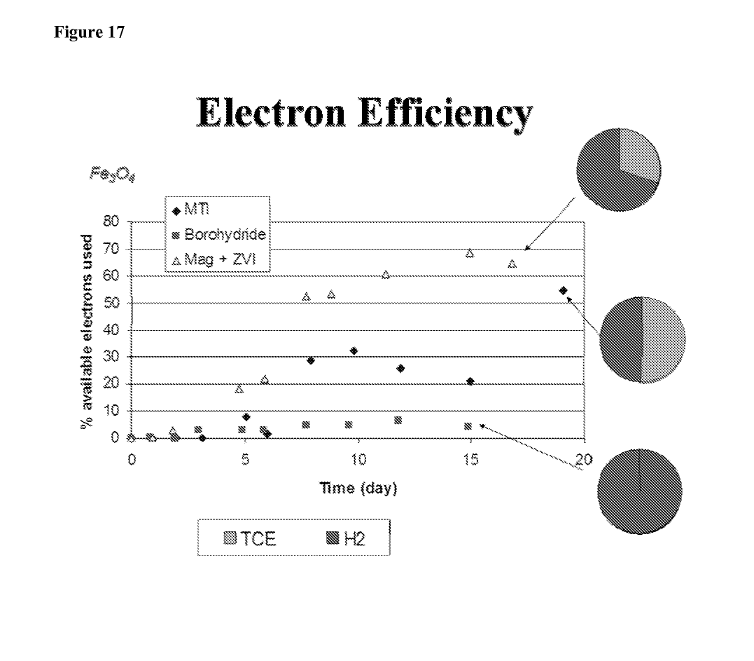

FIG. 18 shows electron utilization of TCE reduction with a variety of alternative iron products.

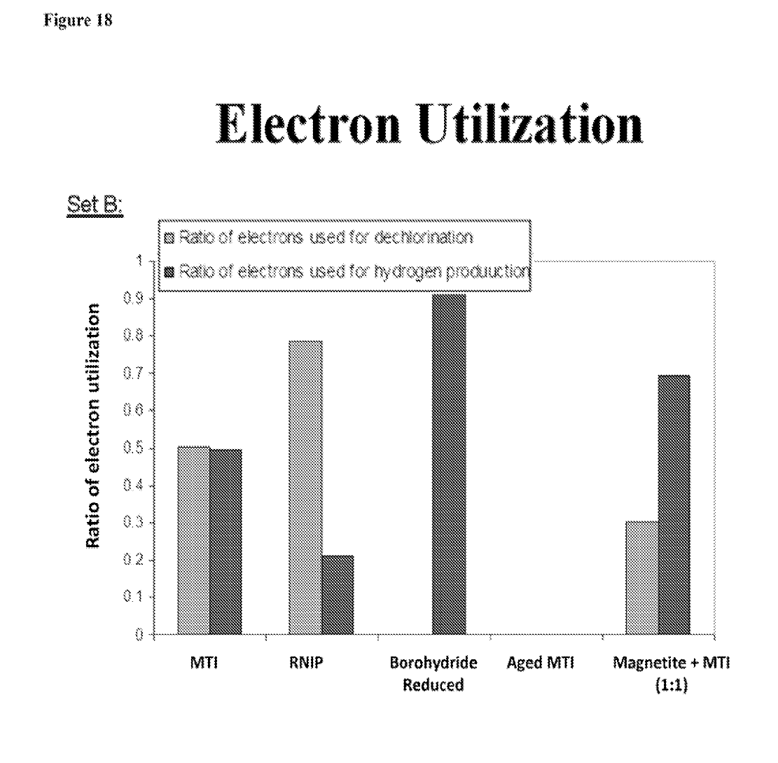

### DEFINITIONS

As used herein, the term “environmental contaminant” refers to any compound not naturally found in a given environment that is harmful to the environment or animals (e.g., humans). In some embodiments, environmental contaminants are found in NAPLs. In some embodiments, environmental contaminants are solvents or industrial biproducts (e.g., including but not limited to, halogenated methanes, ethanes, ethenes and benzenes (e.g. carbon tetrachloride, chloroform, trichloroethene, trichloroethane modified benzenes)). In some embodiments, the environmental contaminant is trichloroethene.

As used herein, the term “neutralizing environmental contaminants” refers to the process of altering environmental contaminants to result in products that are no longer harmful to the environment or animals (e.g., humans). In some embodiments, neutralizing environmental contaminants include dechlorination (e.g., by using ZVI particles).

### DETAILED DESCRIPTION

The present invention relates to remediation of hazardous waste sites. In particular, the present invention relates to compositions and methods for remediation of dense non-aqueous phase liquid (DNAPL).

In some embodiments, the present invention describes the use of reactive slurries or suspensions (usually of reactive zero valent iron (ZVI) particles) for treatment of dense non-aqueous phase liquid (DNAPL) source zones. Effective treatment of NAPL source zones with ZVI particles utilizes delivery of particles into or to the immediate vicinity of the NAPL. To date, the technologies aimed at remediating subsurface contamination relied on the use of aqueous-based ZVI suspensions. When utilizing these aqueous-based suspensions of reactive iron particles, contaminant transformation is dependent upon aqueous phase concentrations controlled by the dissolution of contaminants from DNAPL. This dissolution process has been shown to be rate-limited (e.g., Powers et al., 1994), indicating that the rate of contaminant transformation may be limited by dissolution. Saleh et al. (2005 and 2007) coated ZVI particles with ampiphilic triblock copolymers to promote a mechanism for targeting the NAPL-water interface, but contaminant reduction utilizing this approach is also be limited by dissolution as the reduction still occurs within the aqueous-phase.

Embodiments of the present invention provide an approach that permits iron-mediated destruction of NAPL components within the NAPL itself Reactions within NAPL are an important innovation for source remediation using reactive iron particles because they alleviate limitations to the rate of contaminant destruction due to mass transfer.

The present invention is not limited to a particular type of ZVI. In some embodiments, Reactive Nanoscale Iron Particles (RNIPs) are used. RNIP (RNIP) consists of an elemental iron core (α-Fe) and a magnetite shell (Fe₃O₄).

RNIP may be produced using any number of known methods. In some embodiments, the method described in Toda Kogyo Corporation's patent (Uegami et al., U.S. Patent 2003/0217974 A1; herein incorporated by reference) is utilized. The starting material for RNIP is an aqueous solution of purified ferrous sulfate (FeSO4). Ferrous iron is crystallized and oxidized to form the ferric oxyhydroxide goethite (α-FeO(OH)). Goethite is dehydrated to hematite (Fe2O3). Hematite is reduced to elemental iron (α-Fe) with hydrogen gas (H2). The elemental iron particles are wet milled and dispersed in water thereby the particle surfaces convert to magnetite (Fe3O4).

In some embodiments, reactive iron particles are produced via borohydride reduction (Glavee et al., 1995; herein incorporated by reference in its entirety). In some embodiments, submicron iron particles are utilized.

In some embodiments, MTI iron products are utilized. MTI iron particles comprise an iron core with a small oxide layer on the outside. In some embodiments, MTI iron particles are formed using plasma chemical vapor deposition.

The present invention is not limited to the remediation of a particular solvent or environmental contaminant. Examples of contaminants suitable for remediation using compositions and methods of the present invention include, but are not limited to, halogenated methanes, ethanes, ethenes and benzenes (e.g. carbon tetrachloride, chloroform, trichloroethene, trichloroethane), chromium (Cr₂O₇⁻), arsenic (AsO₄³⁻) and mercury (Hg²⁺). ZVIs degrade perchlorate (ClO₄⁻) to chloride.

ZVIs react with oxidized inorganic (e.g., ferric iron, sulfate, nitrate) and organic constituents (e.g., dichloroethene, trichloroethane) upon contact. The reactions include but are not limited to electron and hydrogen transfer (e.g., substitution, elimination).

In some embodiments, the present invention provides compositions and kits for use of ZVIs in remediation of NAPLs. In some embodiments, ZVIs are encapsulated in an oil in water emulsion for delivery to NAPLs. NAPL chemistry may be controlled using aqueous phase amendments (Ramsburg and Pennell 2002a, 2002b) or oil-in-water emulsions (Ramsburg et al. 2003, Ramsburg et al. 2004, Berge and Ramsburg 2009). The present invention is not limited to a particular mechanism. Indeed, an understanding of the mechanism is not necessary to practice the present invention. Nonetheless, it is contemplated that emulsion based delivery provides an opportunity to target the delivery of remedial amendments to NAPLs through two mechanisms (i) Ostwald ripening; and (ii) droplet coalescence. When delivering ZVI particles to NAPL source zones, coalescence is the operable mechanism, wherein iron-containing oil droplets combine with NAPL to alter the NAPL chemistry and delivery the iron particles.

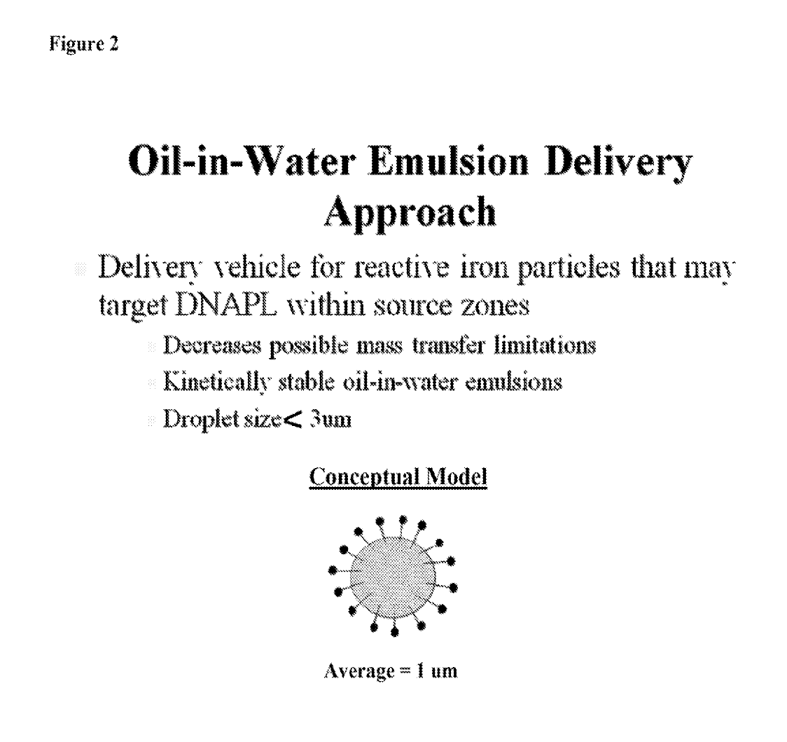

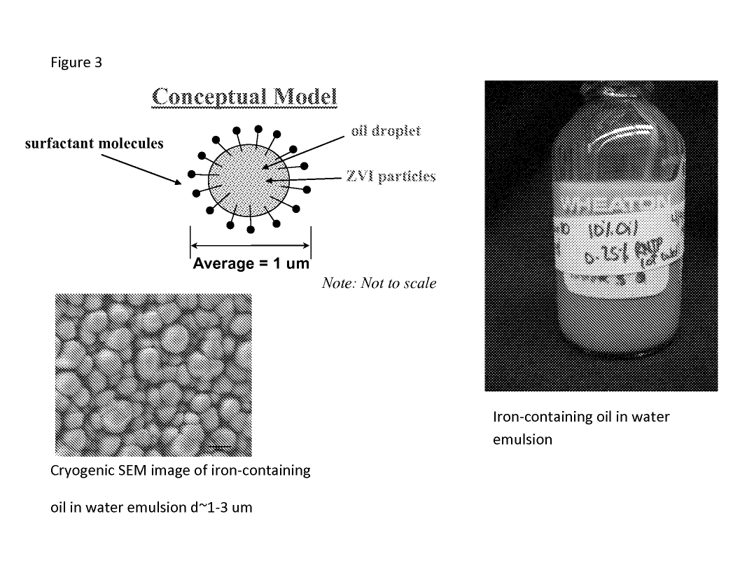

Emulsions used to deliver reactive particles to NAPL source zones are stabilized (short times to coalescence) and posses droplet sizes between 500 nm and 5 um (FIG. 2). Emulsion droplets facilitate the transport of the reactive iron particles (e.g., Berge and Ramsburg 2009) (FIG. 3). In some embodiments, emulsions comprise butanol, gum arabic or lipophilic surfactants (e.g., span 80).

The compositions of embodiments of the present invention find use in the remediation of contaminants (e.g., halogenated contaminants) in NAPLs using ZVI particles or other chemistry. In some embodiments, ZVI compositions of embodiments of the present invention are applied to the surface of a source zone and diffuse into the NAPL. In other embodiments, compositions are administered directly to a NAPL.

### EXPERIMENTAL

The following examples are provided in order to demonstrate and further illustrate certain preferred embodiments and aspects of the present invention and are not to be construed as limiting the scope thereof.

### Example 1

The results described herein show that ZVI mediated reduction of trichloroethylene (TCE) to ethene/ethane within a NAPL is most efficient in the presence of water. The utility of iron-mediated TCE-DNAPL reduction was evaluated with emphasis placed on understanding the influence water content has on the TCE reduction process within a NAPL.

Experiments were conducted in 125-mL serum bottles containing approximately 1.0 to 2.5 g of commercially available iron (Reactive Nanoscale Iron Particles (RNIP) or MTI iron) or iron particles created using a borohydride reduction pathway (e.g., Glavee et al. 1995). Table 1 shows NAPL compositions for reactivity assessment. Fluids placed in the serum bottles comprised 50 g of a TCE, butanol, and water mixture in an argon atmosphere (head space volume is approximately 70 mL). The TCE mixture was designed to ensure initial TCE concentration was constant in all experiments (approximately 230 g/L), while initial water contents (ranging from a mole fraction of 0.3 to 0.02) and butanol concentrations vary. Serum bottles were continuously shaken at 22° C. and destructively sampled over time. Serum bottle pressure was measured using a digital pressure gauge (Model XP2i, Crystal Engineering Corp). Liquid-phase TCE, water content and butanol concentrations were quantified. In addition, gas-phase samples (taken from bottle head space) were sampled over time and used to detect the presence of known reduction products (e.g., acetelyne, ethene, ethane, propane, propene, butane, butene, methane, hydrogen). Concentrations of gas dissolved in the liquid-phase were estimated using experimentally determined partition coefficients.

Little change in liquid concentrations of TCE and butanol concentrations was observed for any of the experiments over the duration of the experiments (16-22 days). The initial TCE concentration were high and the experiments were designed to be iron limited (e.g., it is difficult to quantify small changes in large concentrations). Control reactors containing butanol and iron exhibited no gas production, indicating butanol is not consuming the reactive iron. Thus butanol (or other short chain alcohols or lipophilic surfactants) are suitable to maintain water content within the NAPL (e.g., by creating a thermodynamic driving force for water partitioning into the NAPL). Significant gas production was, however, observed in all experiments containing TCE. The volume of gas produced was observed to be dependent upon water content in the NAPL, as the production of gaseous products increases with increasing water content. The production of dechlorination products indicates that the extent of dechlorination increases with increasing water content. The primary gas produced as a result of reductive dechlorination is ethene. Electron balances suggest that the iron efficiency for the dechlorination reaction is comparable to that observed in studies aimed at assessing iron reactivity within the aqueous phase, as illustrated in Table 2.

Reaction within the NAPL was demonstrated using batch reactors (120 mL total volume) containing 50 mL of NAPL and 70 mL of oxygen-free headspace (initially argon gas). Four NAPL compositions were used to evaluate the influence of NAPL chemistry (i.e., water content) on the dechlorination reaction. NAPL compositions are shown in Table 1. n-butanol is used as a co-solvent to increase the solubility of water in the NAPL. Control experiments indicate n-butanol does not influence the reaction aside from serving as the co-solvent to increase the water content.

Batch reactors were sacrificially sampled for product production (e.g., acetylene, cis-dichloroethene, vinyl chloride, ethene, ethane, hydrogen, butenes, butane, propane, propene, and methane). Only hydrogen, acetylene, ethene, and ethene were found above trace levels, indicating these are the primary reaction products for the dechlorination of TCE within the NAPL. In addition, reactors were sampled for headspace pressure, NAPL density, and NAPL water content. Compositional analyses were used to estimate partial pressures (assuming ideal gases) for each reaction product (and all components of the NAPL). In this manner the compositional data and pressure data were used to verify (i) the reaction, and (ii) that no major reaction product went undetected.

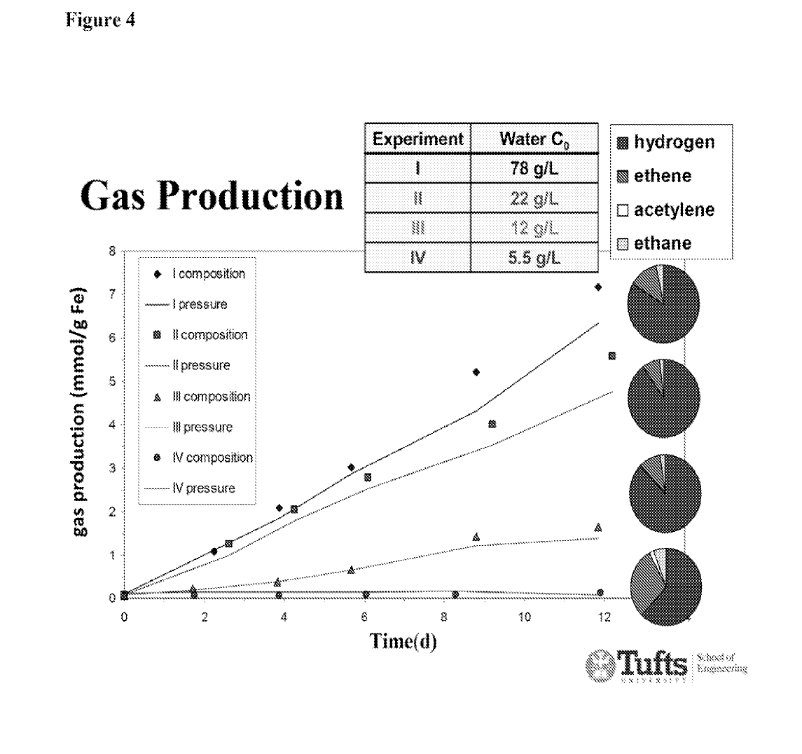

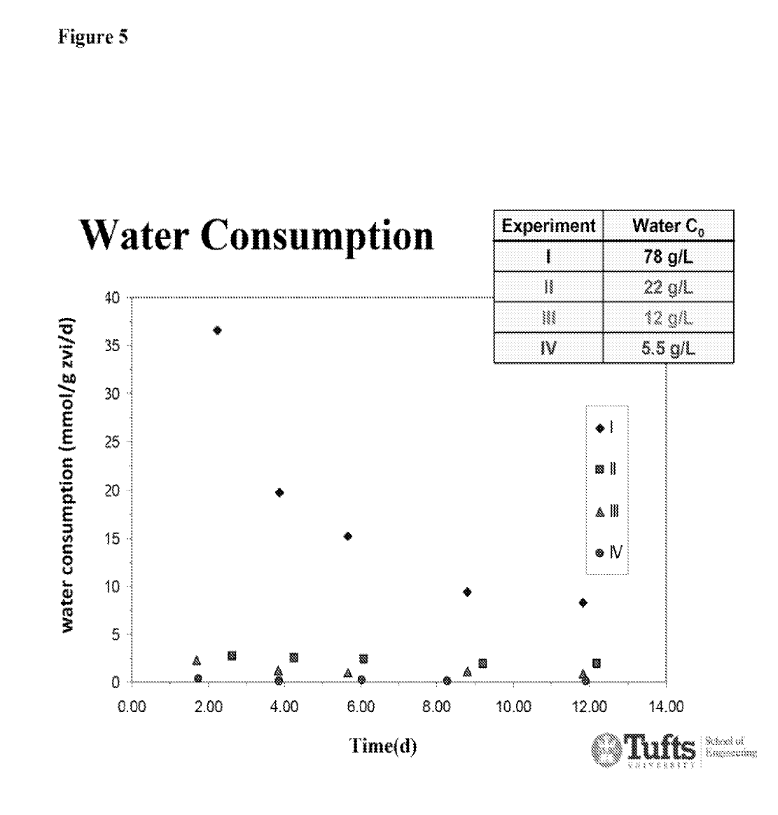

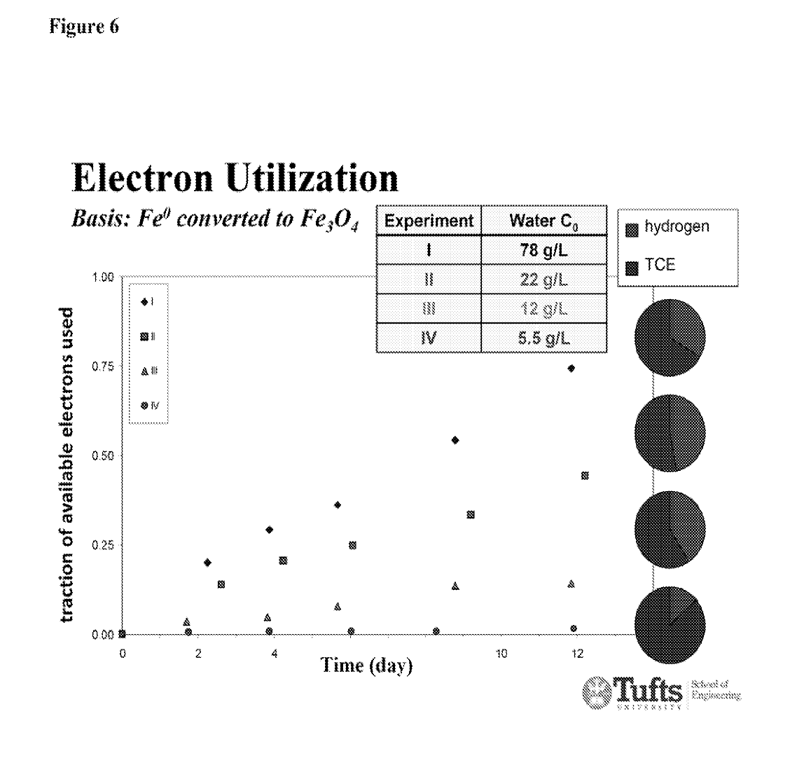

Shown in FIG. 4 are pressure data for each initial NAPL composition. These data include pressure measurements and estimates of pressures through the compositional analysis. The data demonstrate a strong correlation between reactivity and water content. Also shown in FIG. 4 are the relative abundances of each of the major reaction products at approximately 12 day. Water consumption within the NAPL through these experiments is shown in FIG. 5. Reactions within the NAPL can utilize the electrons within the ZVI to the same extent as what has been observed in aqueous phase reactions (FIG. 6).

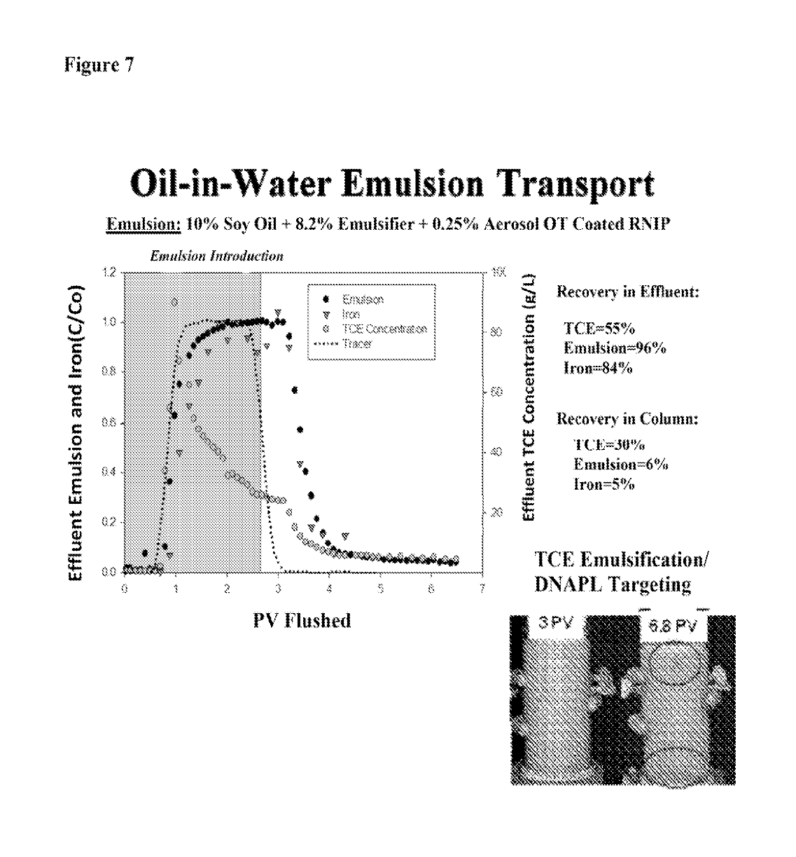

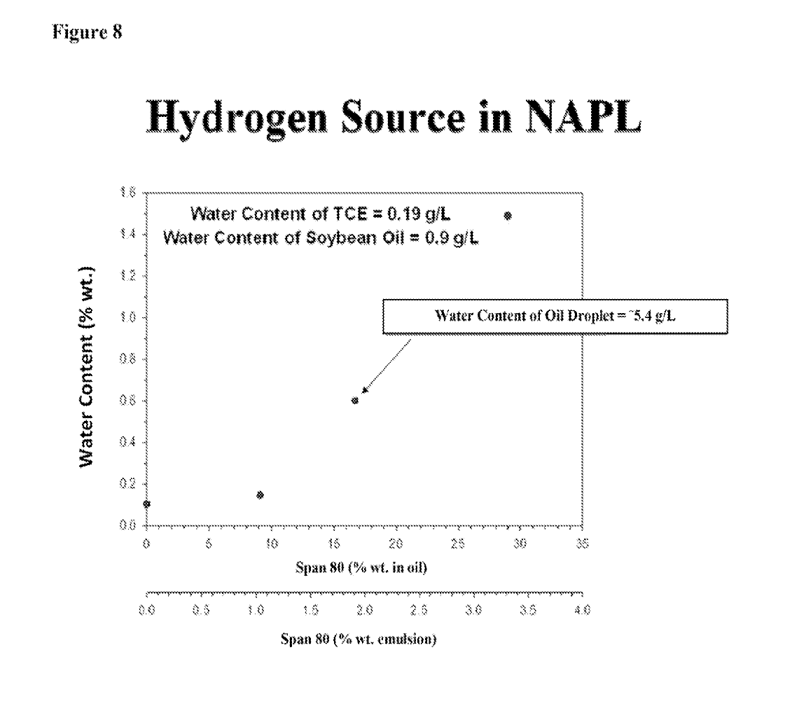

Shown in FIG. 7 are data indicating the targeted delivery of reactive iron particles to the NAPL. Results indicate that iron containing emulsions are an effective combined remedy—one that can remove (through emulsification) significant (>50%) of NAPL mass, while delivering iron particles to the remaining NAPL for contaminant transformation. Use of the emulsion is particularly synergistic for reactivity within the NAPL because one of the stabilizers (Span 80) can increase water content in the NAPL through the formation of reverse micelles (FIG. 8).

Overall the results describe the utility of the methods in iron mediated remediation of chloroethene NAPLs. Specially, it was demonstrated that control of NAPL chemistry permits dechlorination reactions to occur within the NAPL to the same extent (per mass of iron) as observed in the aqueous phase. This result is contrary to conventional wisdom which suggests that iron is nonreactive (or has very limited reactivity) with chlorinated solvents.

TABLE 1

| Experiment | TCE | Water |
|---|---|---|
| I | 0.12 (230 g/L) | 0.30 (78 g/L) |
| II | 0.14 (230 g/L) | 0.10 (22 g/L) |
| III | 0.15 (230 g/L) | 0.06 (12 g/L) |
| IV | 0.16 (230 g/L) | 0.03 (5.5 g/L) |

balance (620-680 g/L) is n-butanol, a low molecular weight alcohol which is not consumed in the presence of iron

TABLE 2
Comparison of electron balances observed
in studies assessing iron reactivity.

| | | | % Electrons used |
|---|---|---|---|
| | | Liquid used | for Reductive |
| Source | Iron Product | in study | Dechlorination¹ |
| Lui et al., 2005 | RNIP | Aqueous | 52 |
| Lui et al., 2005 | Iron produced | Aqueous | 92 |
| | via borohydride | | |
| | reduction | | |
| Liu et al., 2007 | RNIP | Aqueous | up to 50² |
| Example 1 | RNIP | NAPL | up to 100³ |

¹assumes 2 electrons per mole of ZVI are available for reaction
²range is a result of different initial TCE concentrations
³range is due to different initial water contents; Note that % utilization of electrons exceeds 100% suggesting the possibility of forming iron minerals with average Fe oxidation states in excess of +2.

All publications and patents mentioned in the above specification are herein incorporated by reference as if expressly set forth herein. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in relevant fields are intended to be within the scope of the following claims.

We claim:

1. A method of neutralizing environmental contaminants within non-aqueous phase liquid, comprising:
Contacting a non-aqueous phase liquid (NAPL) comprising an environmental contaminant with components of a chemical or biological reaction under conditions such that said reaction neutralizes said environmental contaminant within said NAPL.

2. The method of claim 1, wherein said components comprise reactive zero valent iron (ZVI).

3. The method of claim 2, wherein said ZVI is a Reactive Nanoscale Iron Particle (RNIP).

4. The method of claim 1, wherein said environmental contaminant is selected from the group consisting of halogenated methanes, ethanes, ethenes and benzenes.

5. The method of claim 4, wherein said halogenated group is selected from the group consisting of carbon tetrachloride, chloroform, trichloroethene, and trichloroethane.

6. The method of claim 1, wherein said environmental contaminant is dechlorinated.

7. The method of claim 1, wherein said NAPL comprises more than one distinct environmental contaminant.

8. The method of claim 1, wherein said non-aqueous phase liquid is a dense non-aqueous phase liquid (DNAPL).

9. The method of claim 1, wherein said ZVI is encapsulated in an emulsion.

10. The method of claim 9, wherein said emulsion is an oil in water emulsion.

11. The method of claim 10, wherein said emulsion comprises a stabilizer selected from the group consisting of butanol, span 80 and gum arabic.
